(19) United States
(12) Patent Application Publication
(10) Pub. No.: US 2014/0157964 A1
(43) Pub. Date: Jun. 12, 2014

(54) Underwater Wire Saw And Method Of Use

(71) Applicants: John Edward Davis, Magnolia, TX (US); Noah Kirk Teichmiller, Houston, TX (US); William Joey Tabor, Magnolia, TX (US); Charles Robert Mynhier, Magnolia, TX (US)

(72) Inventors: John Edward Davis, Magnolia, TX (US); Noah Kirk Teichmiller, Houston, TX (US); William Joey Tabor, Magnolia, TX (US); Charles Robert Mynhier, Magnolia, TX (US)

(73) Assignee: OCEANEERING INTERNATIONAL, INC., Houston, TX (US)

(21) Appl. No.: 14/103,673

(22) Filed: Dec. 11, 2013

Related U.S. Application Data
(60) Provisional application No. 61/736,406, filed on Dec. 12, 2012.

(51) Int. Cl. B23D 57/00

(52) U.S. Cl. CPC B23D 57/0084; B23D 57/0069
USPC 83/56; 83/581.1

(57) ABSTRACT

In embodiments, an underwater wire saw comprises a frame, one or more arms connected to the frame with a predetermined number of the arms comprising a wire tensioner and a selectively telescoping or collapsing tube within a tube, and a continuous wire guided by a plurality of wire guides and tensioned using the wire tensioner. The underwater wire saw may further comprise a clamp.

### PRIORITY

This application relates to and claims the benefit of U.S. Provisional Application No. 61/736,406 filed on Dec. 12, 2012.

### BACKGROUND

The invention relates to wire saw devices and, more particularly, to diamond or carbide wire saw devices having a continuous wire suitable for subsea cutting applications.

Structures such as pipes often need to be cut subsea. Prior art cutting systems have employed multiple component cutting assemblies comprising pulleys, a cutting blade, and related structure, but must move so as to traverse the diameter of the object to be cut. The movement of such multiple component cutting means is often cumbersome and requires significant clearance on multiple sides of the object to be cut such as to maneuver when preparing for and performing the desired cutting operation.

### FIGURES

Various figures are included herein which illustrate aspects of embodiments of the disclosed inventions.

FIG. 1 is a top down planar view of an exemplary embodiment of an underwater wire saw;

FIG. 2 is a side planar view of an exemplary embodiment of an underwater wire saw first arm;

FIG. 3 is a side planar view of an exemplary embodiment of an underwater wire saw second arm;

FIG. 4 is a top down planar view of an exemplary embodiment of an underwater wire saw as it engages a subsea structure; and

FIG. 5 is a top down planar view of an exemplary embodiment of an underwater wire saw after it has engaged a subsea structure.

### DESCRIPTION OF SELECTED EMBODIMENTS

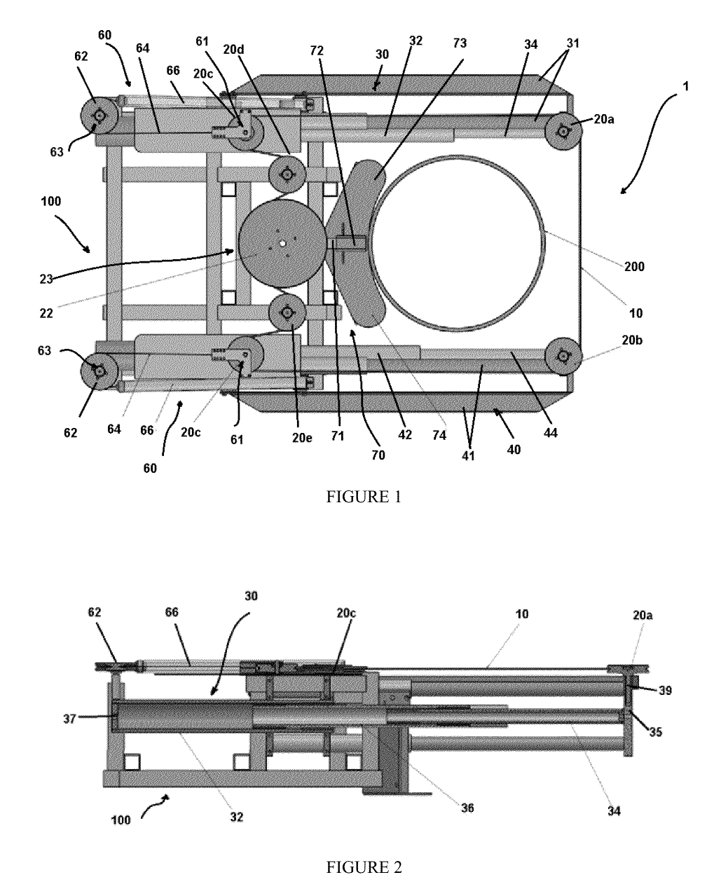

Referring to FIGS. 1 and 2, in an embodiment underwater wire saw 1 comprises frame 100; first arm 30 movably connected to frame 100; a plurality of wire guides 20, at least one of which is connected to first arm 30; a substantially continuous wire 10 movably in communication with the plurality of wire guides 20; a continuous wire driver 22 operatively in communication with wire 10; and tensioner 60 connected to frame 100, where tensioner 60 is dimensioned and adapted to guidingly receive and adjust tension on wire 10.

In a second embodiment, underwater wire saw 1 comprises frame 100; a substantially continuous wire 10 movably in communication with wire guides 20; first arm 30 connected to frame 100; second arm 40, which may be substantially identical to first arm 30 and movably connected to frame 100 on a side opposite first arm 30 in a predetermined parallel plane relative to frame 100 and wire 10; a plurality of wire guides 20; continuous wire driver 22 operatively in communication with wire 10; and one or more tensioners 60 connected to frame 100 where tensioner 60 is dimensioned and adapted to receive, guide, and adjust tension on wire 10.

Wire guides 20 typically comprise first sheave 20a connected to first arm 30 at tube connection end 35; third sheave 20d connected to frame 100; and fourth sheave 20e connected to the frame. In embodiments which include second arm 40, wire guides 20 may further comprise second sheave 20b connected to second arm 40 at tube connection end 45.

Substantially continuous wire 10 is of a type to effect cutting of subsea structure 200. In embodiments wire 10 comprises a diamond wire, a carbide wire, or the like.

Wire driver 22 comprises power source interface 23 and can comprise a motor or the like, operative to engage and move wire 10 in a loop. In embodiments, power source interface 23 comprises an interface to power source 82 (FIG. 4) which can be a source of hydraulic power electrical power as the situation requires such as ROV 300 (FIG. 4).

Referring more specifically to FIG. 2, in an embodiment, first arm 30 is slidingly attached to frame 100 and comprises first tube 32; second tube 34 dimensioned to slidingly fit within first tube 32; and first tube positioner 36 disposed within first tube 32 and operatively in communication with second tube 34. First tube positioner 36 is operative to adjustably move second tube 34 within first tube 32. In preferred embodiments, first tube positioner 36 is or acts like a piston and comprises first power interface 37. Although described herein as tubes, first tube 32 and second tube 34 can be of any cooperatively shaped geometry. By way of example and not limitation, first tube 32 and second tube 34 may be a telescoping cylinder or rectangular in shape.

First arm 30 may further comprise one or more rails 31 (FIG. 1) to which first tube 32 may be connected where rails 31 engage frame 100 (FIG. 1) to allow first arm 30 to slide or otherwise move parallel to a plane defined by frame 100.

First arm 30 may further comprise a separate tube connection end 35 piece, as illustrated in FIG. 2, or an integrated tube connection end 35. Tube connection end 35 is typically dimensioned and configured to support a wire guide or sheave such as first sheave 20a. Tube connection end 35 may further support spindle 39 to which sheave 20a is rotatably connected.

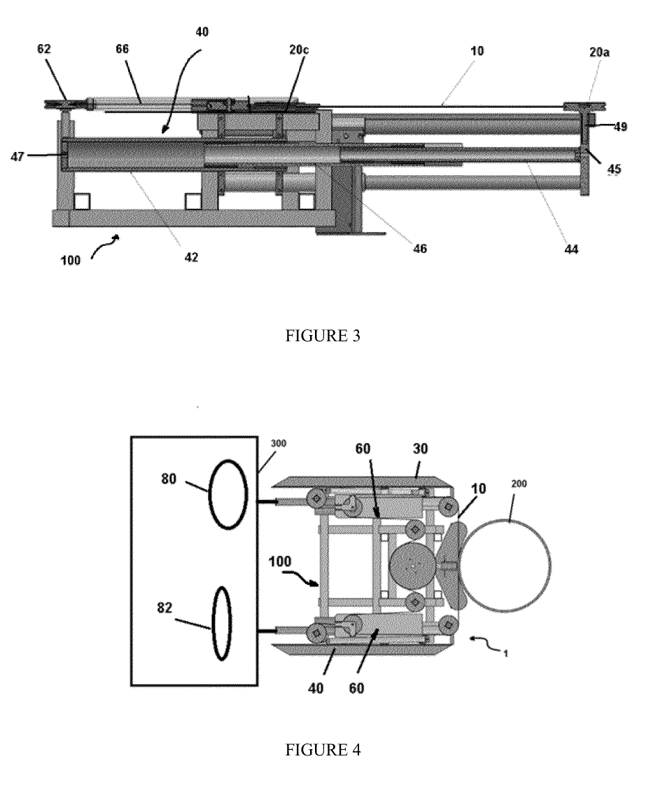

Referring additionally to FIG. 3, in embodiments, second arm 40 may be a simple support structure or, in other embodiments, substantially identical to first arm 30 and slidingly attached to frame 100. In this second embodiment, third arm 40 comprises third tube 42; fourth tube 44 dimensioned to slidingly fit within third tube 42; and second tube positioner 46 disposed within third tube 42 and operatively in communication with fourth tube 44. In this second embodiment, second tube positioner 46 is operative to adjustably move fourth tube 44 within third tube 42 and comprises second power interface 47. Although described herein as a tube, third tube 42 and fourth tube 34 can be of any cooperatively shaped geometry, e.g. by way of example and not limitation, a telescoping cylinder or rectangular in shape. As noted, in embodiments second arm 40 need not comprise third tube 42, fourth tube 44, or second tube positioner 46 because first arm 30 alone may provide the required tensioning. Second arm 30 may further comprise tube connection end 45 which is a separate piece, as illustrated in FIG. 3, or an integrated tube connection end 45. Tube connection end 45 is typically dimensioned and configured to support a wire guide or sheave such as second sheave 20b.

Second arm 40 may further comprise one or more rails 41 (FIG. 1) to which third tube 42 may be connected where rails 41 engage frame 100 to allow second arm 40 to slide or otherwise move parallel to a plane defined by frame 100, either independently or cooperatively with first arm 30.

Tube connection end 45 is typically dimensioned and configured to support a wire guide or sheave such as first sheave 20b. Tube connection end 45 may further support spindle 49 to which sheave 20b is rotatably connected.

First tube positioner 36, and, if present, second tube positioner 46, comprises an interface to power source 80 (FIG. 4), e.g. first power interface 37 and, if present, second power interface 47. In embodiments, these can be fluid interfaces such as when power source 80 comprises a hydraulic power source to supply sea water, air, or hydraulic fluid, or the like, or a combination thereof. In other embodiments, power source 80 may supply appropriate power such as electrical power. Power may be supplied from remotely operated vehicle 300 (FIG. 4), e.g. subsea, or from any other appropriate power source as the situation requires. It is understood that power sources 80 and 82 may be the same power source or different power sources and may be located elsewhere other than ROV 300, e.g. on a sled (not shown in the figures) or other subsea structure (not shown in the figures).

Referring back to FIG. 1, tensioner 60 is typically connected to one or the other of first arm 30 or second arm 40 and typically further comprises tensioning cylinder 66 connected to a respective arm, i.e. first arm 30 or second arm 40; tensioning sheave 20c connected to tensioner end 61, where tensioning sheave 20c is dimensioned and adapted to receive and guide substantially continuous wire 10; tensioning cable 64 connected to tensioner end 61 and tensioning cylinder 66; and tensioning cable sheave 62 connected to tensioning cable sheave end 63 of frame 100 and adapted to receive and guide tensioning cable 66. In certain embodiments, such as when second arm 40 is substantially identical to first arm 30, a plurality of tensioners 60 may be used where each tensioner 60 is dimensioned and adapted to movingly receive and adjust tension on wire 10, either cooperatively or separately.

Referring still to FIG. 1, in embodiments underwater wire saw 1 further comprises clamp 70, which comprises clamp arm 71 connected to frame 100; one or more clamp arm receivers 72 dimensioned and adapted to receive clamp arm 70; and one or more positioning arms 73,74 connected to clamp arm receiver 72. It is understood that positioning arms 73 and 74 may be one arm or a plurality of arms.

In these clamp embodiments, clamp 70 is typically static in a desired plane to engage and retain subsea structure 200 such as when first arm 30 and second arm 40 are positioned to an aft position relative to frame 100 such that positioning arms 73,74 extend beyond wire 10 relative to frame 100. Positioning arms 73,74 may be of the type familiar to those of ordinary skill in the subsea arts and may articulate about a pivot point such as pivot 75.

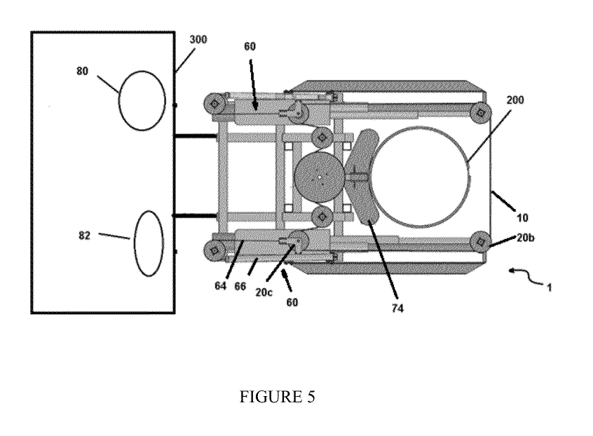

In the operation of preferred embodiments, referring additionally to FIGS. 4 and 5, subsea structure 200 may be cut by positioning underwater wire saw 1 proximate subsea structure 200, where underwater wire saw 1 is described above, such as by using ROV 300 to grasp and maneuver underwater wire saw 1 to a desired position. Wire 10 may be at an initial tension that is not its final tension. Once in position, the tension in cutting wire 10 may be adjusted to a desired tension by using one or more tensioners 60.

Once the desired tension in cutting wire 10 is obtained, cutting wire 10 is moved towards and against subsea structure 200. This can be accomplished by using ROV 300 or a diver and by moving frame 100 relative to first arm 30 and/or second arm 40, if second arm 40 is present.

Once underwater wire saw 1 is positioned, wire 10, which is received by wire guides 20 (e.g. one or more of sheaves 20a, 20b, 20d, 20e) which are used to guide cutting wire 10 as it cuts through subsea structure cut 200, may be engaged with drive mover 22. Wire 10 is also in movable communication with each tensioning sheave 20c which is used, along with tensioner 60 components such as tensioning cylinder 66, to achieve and maintain a desired tension on wire 10 as it is engaged against subsea structure 200.

Typically, adjusting tension in cutting wire 10 comprises adding or removing a fluid to cylinder 66 to increase or decrease a pull on tension cable 64 and allowing tension cable 64 to increase or decrease the pull on tensioning sheave 20c, thereby increasing tension of cutting wire 10. As noted above, in certain embodiments a plurality of tensioners 60 may be present in which case tension in cutting wire 10 may be adjusted by using a predetermined number of tensioning cylinders 66 of a predetermined set of the plurality of tensioners 60. By way of example and not limitation, each of the plurality of tensioners 60 may be cooperatively or separately adjustable.

Cutting wire is circulated in a loop using wire driver 22 and underwater wire saw 1 is advanced in a predetermined plane relative, and substantially parallel, to frame 100 until a desired cut into subsea structure 200 has been achieved, e.g. by using ROV 300. During cutting, a substantially constant tension may be maintained by maintaining the pressure in tensioning cylinder 66.

In certain embodiments, clamp 70, as described above, is connected to underwater wire saw 1 prior to advancing underwater wire saw 1 towards subsea structure 200 such as by using ROV 300. Clamp 70 receives subsea structure 200 such as into positioning arms 73,74 which can then be used to secure subsea structure 200 into clamp 70, as will be familiar to those of ordinary skill in the subsea arts. Typically, portions of underwater wire saw 1 (e.g. first arm 30 and second arm 40) are positioned to an aft position relative to frame 100 such that positioning arms 73,74 extend beyond wire 10 relative to frame 100 towards subsea structure 200 which can be a pipe. Once received and optionally secured, e.g. prior to engaging subsea structure 200 with cutting wire 10, subsea structure 200 can be retained into and optionally secured by clamp 70 while underwater wire saw 1 is advanced in the predetermined plane until the desired cut into subsea structure 200 has been achieved. As this occurs, frame 100 may be maintained in a relatively constant position offset from subsea structure 200 and first arm 30 (and second arm 40, if present) advanced such as by a motor or gearing system or the like or a combination thereof. As one or both of first arm 30 and second arm 40 are advanced, tension in wire 10 is maintained, as described herein.

The foregoing disclosure and description of the inventions are illustrative and explanatory. Various changes in the size, shape, and materials, as well as in the details of the illustrative construction and/or an illustrative method may be made without departing from the spirit of the invention.

We claim:

1. An underwater wire saw, comprising:
a. a frame;
b. a first arm movably connected to the frame;
c. a plurality of wire guides, at least one of which is connected to the first arm;
d. a substantially continuous wire movably in communication with the plurality of wire guides;
e. a continuous wire driver operatively in communication with the wire; and
f. a tensioner connected to the frame, the tensioner dimensioned and adapted to guidingly receive and adjust tension on the wire.

2. The underwater wire saw of claim 1, wherein the first arm further comprises:
a. a rail;
b. a first tube connected to the rail;
c. a second tube dimensioned to slidingly fit within the first tube; and
d. a first tube positioner disposed within the first tube and operatively in communication with the second tube, the first tube positioner operative to adjustably move the second tube within the first tube, the first tube positioner comprising a first power interface.

3. The underwater wire saw of claim 1, wherein the wire guides further comprise:
a. a first sheave connected to the second tube at a tube connection end;
b. a second sheave connected to the frame; and
c. a third sheave connected to the frame;

4. The underwater wire saw of claim 1, wherein the first power interface comprises a fluid interface to a power source.

5. The underwater wire saw of claim 4, wherein the power source comprises a hydraulic power source.

6. The underwater wire saw of claim 5, wherein the hydraulic power source comprises at least one of sea water, air, or hydraulic fluid.

7. The underwater wire saw of claim 1, wherein the substantially continuous wire comprises a diamond wire or a carbide wire.

8. The underwater wire saw of claim 1, wherein the wire driver comprises a wire driver power source interface to a wire driver power source.

9. The underwater wire saw of claim 8, wherein the wire driver power source comprises at least one of a hydraulic power source or an electrical power source.

10. The underwater wire saw of claim 1, wherein:
a. the frame further comprises a tension sheave connector end and a tensioning cable connection point; and
b. the tensioner further comprises:
i. an tensioning cylinder connected to the frame;
ii. a tensioning sheave connected to the frame, the tensioning sheave dimensioned and adapted to guidingly receive the substantially continuous wire;
iii. a tensioning cable connected to the tensioning cable connection point and the tensioning cylinder; and
iv. a tensioning cable sheave connected to the frame proximate the tension sheave connector end, the tensioning cable sheave adapted to guidingly receive the tensioning cable.

11. The underwater wire saw of claim 1, further comprising:
a. a second arm connected to the frame substantially opposite the first arm parallel to the first arm in a plane defined by the frame, the second arm comprising:
i. a rail;
ii. a third tube;
iii. a fourth tube dimensioned to slidingly fit within the third tube; and
iv. a second tube positioner disposed within the third tube and operatively in communication with the fourth tube, the second tube positioner operative to adjustably move the fourth tube within the third tube, the second tube positioner comprising a second power interface.

12. The underwater wire saw of claim 11, further comprising a fourth sheave connected to the fourth tube at a tube connection end.

13. The underwater wire saw of claim 11, wherein the first power interface and the second power interface each comprises a fluid interface to a power source.

14. The underwater wire saw of claim 11, wherein the first tube positioner power interface and the second tube positioner power interface are dimensioned and adapted to receive power from a remotely operated vehicle.

15. The underwater wire saw of claim 11, further comprising two tensioners connected to the frame substantially opposite each other in a plane defined by the frame, each tensioner dimensioned and adapted to movingly receive and adjust tension on the wire.

16. The underwater wire saw of claim 1, further comprising a clamp, the clamp comprising:
a. a clamp arm connected to the frame;
b. a clamp arm receiver dimensioned and adapted to receive the clamp arm; and
c. a positioning arm connected to the clamp arm receiver.

17. A method of cutting a subsea structure, comprising:
a. positioning an underwater wire saw proximate a subsea structure, the underwater wire saw comprising:
i. a frame;
ii. a first arm movably connected to the frame;
iii. a plurality of wire guides, at least one of which being connected to the first arm;
iv. a substantially continuous wire movably in communication with the wire guides;
v. a continuous wire driver operatively in communication with the wire; and
vi. a tensioner connected to the frame and operatively in communication with the wire, the tensioner dimensioned and adapted to guidingly receive and adjust tension on the wire;
b. engaging the subsea structure with the cutting wire;
c. using the adjusting tension in the cutting wire to a desired tension;
d. advancing the cutting wire against the subsea structure;
e. turning the cutting wire in a loop using the continuous wire mover;
f. using the wire guides to guide the cutting wire from the wire driver and the tensioner in the loop; and
g. advancing the first arm in a predetermined plane until a desired cut into the subsea structure has been achieved.

18. The method of claim 17, further comprising:
a. attaching a clamp to the underwater wire saw, the clamp comprising:
i. a clamp arm connected to the frame;
ii. a clamp arm receiver dimensioned and adapted to receive the clamp arm; and
iii. a positioning arm connected to the clamp arm receiver;
b. moving the underwater wire saw to a position relative to the frame where the positioning arm extends beyond the wire relative to the subsea structure;
c. receiving the subsea structure into the clamp;
d. securing the subsea structure into the clamp; and
e. continuing the secure the subsea structure into the clamp while advancing the first arm in a predetermined plane until a desired cut into the subsea structure has been achieved.

19. The method of claim 18, wherein the subsea structure is secured into the clamp prior to engaging the subsea structure with the cutting wire.

20. The method of claim 13, wherein:
a. the tensioner further comprises:
i. an tensioning cylinder connected to the frame;
ii. a tensioning sheave connected to the first arm tension sheave connector end, the tensioning sheave dimensioned and adapted to guidingly receive the substantially continuous wire;
iii. a tensioning cable connected to the first arm tensioning cable connection point and the tensioning cylinder; and
iv. a tensioning cable sheave adapted to guidingly receive the tensioning cable; and
b. adjusting the tension in the cutting wire by using the tensioning cylinder.

21. The method of claim 20, wherein adjusting tension in the cutting wire comprises:
a. adding or removing a fluid to tensioning cylinder to increase or decrease a pull on the tensioning cable; and
b. allowing the tensioning cable to increase or decrease the pull on the tensioning sheave, thereby increasing or decreasing tension of the cutting wire.

22. The method of claim 20, further comprising maintaining a substantially constant tension throughout the cutting process by maintaining the pressure in the tensioning cylinder.

23. The method of claim 17, wherein:
a. the underwater wire saw comprises a second arm attached to the frame, the second arm substantially identical to the first arm; and
b. tension in the cutting wire is adjusted by using at least one of the tensioning cylinders.

24. The method of claim 23, wherein tension in the cutting wire is adjusted by using both of the tensioners either cooperatively or separately.
